(19) United States
(12) Patent Application Publication
(10) Pub. No.: US 2017/0348836 A1
(43) Pub. Date: Dec. 7, 2017

(54) Torque Wrench

(71) Applicant: Bobby Hu, Taichung (TW)

(72) Inventor: Bobby Hu, Taichung (TW)

(21) Appl. No.: 15/494,608

(22) Filed: Apr. 24, 2017

(30) Foreign Application Priority Data
Jun. 7, 2016 (TW) 105118013

(51) Int. Cl. B25B 23/142; B25B 23/14; B25B 23/00

(52) U.S. Cl. CPC B25B 23/1427; B25B 23/1425; B25B 23/0028; B25B 23/141

(57) ABSTRACT

A torque wrench includes a driving device having a connecting rod pivotably connected to a body. The connecting rod is pivotably connected to a head of the driving device and is pivotable between first and second positions. The torque wrench has first and second lever arms corresponding to the first and second positions, respectively. A torque device is mounted to the body and presses against an abutting end of the connecting rod. An adjusting device is movably mounted to the body and is operatively connected to the torque device for setting an initial torque value. A measuring unit measures the initial torque value. An operating unit multiplies the initial torque value by a first or second correction coefficient corresponding to the first or second lever arm to obtain a corrected torque value. A display unit displays the corrected torque value.

### BACKGROUND

The present invention relates to a torque wrench and, more particularly, to a torque wrench permitting adjustment of a working angle and digitally showing the adjusted torque value after a change in the working angle.

Generally, to precisely tighten a fastener (such as a screw, a nut, or a bolt) to a set torque value according to its original specification, a user must tighten the fastener to a certain extent and then uses a torque wrench of the set torque value to proceed with the final adjustment.

There are various torque wrenches available in the market. These torque wrenches can be classified into electric, hydraulic, and manual types according to the power source. Manual torque wrenches can be further classified into mechanical and electronic types.

U.S. Pat. No. 6,722,235 discloses a torque wrench with a scale. The torque wrench is of mechanical type and includes an adjusting knob rotatably attached to an end of a shank. A stepped protrusion is formed on the adjusting knob and is connected to a pushing bar of a torque-adjusting device. The pushing bar is rotated when the adjusting knob is rotated. Due to the threaded engagement between a pushing sleeve and the pushing bar, the pushing sleeve will move relative to the shank to compress or stretch a biasing member. Accordingly, the torque value provided by the wrench is adjusted.

U.S. Pat. No. 6,981,436 discloses an electronic torque wrench using strain gauges to detect the torque of the wrench which is applied to a processor through an analog-to-digital converter, and the torque value is rapidly displayed on an LCD display. Due to provision of the gauges, pivotal movement between the head and the sensory yoke is allowed to permit adjustment of the working angle, and the real torque value after a change in the lever aim resulting from adjustment of the working angle can be immediately measured through the amount of strain.

The mechanical torque wrenches and electronic torque wrenches are substantially different in structure. A mechanical torque wrench uses a torque release device to hint the set torque value has been reached. The torque release device generally includes a spring, a release joint, and a tappet. A user firstly sets the required torque value of the torque wrench. At this time, the spring mounted around the tappet exerts a force on the release joint. When the torque wrench is used to drive a fastener and reaches the set torque value, the torque value will be larger than the force exerted on the release joint by the spring to create an instantaneous disengagement effect. An audible sound resulting from impacting a metal housing of the torque wrench is generated to remind the user that the set torque value has been reached. Thus, mechanical torque wrenches have a complicated structure. By contrast, electronic torque wrenches only require mounting strain gauges on an ordinary wrench to achieve instant measurement of the torque value.

However, operation of mechanical torque wrenches is apt to be affected by obstacles in the working environments. Specifically, due to the inherent structural limitation, the working angle of a mechanical torque wrench cannot be changed after setting the torque value. Namely, the lever arm of the torque wrench is changed when the working angle varies, leading to a change in the set torque value. Thus, the mechanical torque wrench cannot obtain a precise torque value. Consequently, unlike electronic torque wrenches with strain gauges, the mechanical torque wrench cannot instantly measure the torque value after adjustment of the working angle and is, thus, difficult to provide the function of adjusting the working angle. As a result, conventional mechanical wrenches cannot change the working angle or cannot provide the precise torque value after the working angle is changed.

However, electronic torque wrenches completely reply on electronic components, particularly strain gauges, and, thus, have a high cost, failing to provide a high capability/price ratio. Furthermore, although an electronic torque wrench can instantly display the torque valve after the working angle is changed, the torque value continuously changes during rotation of the torque wrench rotated by the user, such that it is difficult for the user to judge whether the desired torque value is reached. Furthermore, as can be seen from FIG. 2 of U.S. Pat. No. 6,981,436, many options of the working angle between the head and the sensory yoke of the wrench result in complicated operation.

Thus, a need exists for a novel torque wrench to mitigate and/or obviate the above disadvantages.

### BRIEF SUMMARY

A torque wrench according to the present invention includes a body having a first end and a second end. A driving device includes a connecting rod and a head. The connecting rod is pivotably connected to the first end of the body. The connecting rod includes a pivotal end and an abutting end. The pivotal end is pivotably connected to the head. The connecting rod is pivotable relative to the head between a first position and a second position. The torque wrench has a first lever arm when the connecting rod is in the first position. The torque wrench has a second lever arm when the connecting rod is in the second position. A torque device is mounted to the body and presses against the abutting end of the connecting rod. An adjusting device is movably mounted to the second end of the body and is operatively connected to the torque device for setting an initial torque value. An operating device is mounted to the body. The operating device includes a measuring unit, an operating unit, and a display. The measuring unit, the operating unit, and the display unit are electrically connected to each other. The measuring unit is configured to measure the initial torque value.

The operating unit has a first mode and a second mode. When the operating unit is in the first mode, the operating unit multiplies the initial torque value by a first correction coefficient corresponding to the first lever arm to obtain a first corrected torque value. When the operating unit is in the second mode, the operating unit multiplies the initial torque value by a second correction coefficient corresponding to the second lever arm to obtain a second corrected torque value. The display unit displays the first corrected torque value or the second corrected torque value according to the first mode or the second mode of the operating unit.

In an example, the body is a hollow cylindrical member. The connecting rod extends along a first axis. The pivotal end is spaced from the abutting end along the first axis. The head is adapted to drive a fastener to rotate about a rotating axis. The head extends along a second axis perpendicular to the rotating axis. The pivotal end of the connecting rod is spaced from the rotating axis along the second axis. The first axis is coincident with the second axis when the connecting rod is in the first position. When the connecting rod is in the second position, the first axis is at an angle of 15° to the second axis. The torque device elastically presses against the abutting end of the connecting rod.

In an example, a receptacle is defined in the pivotal end of the connecting rod and extends along a sliding axis perpendicular to the first axis. The pivotal end of the connecting rod includes two arms defining a pivotal groove therebetween. The pivotal groove intercommunicates with the receptacle via a passage. The head includes a pivotal portion received in the pivotal groove between the two arms. The torque wrench further includes a pivotal member extending through the two arms and the pivotal portion to permit the connecting rod to pivot relative to the head between the first position and the second position. A positioning device is mounted in the receptacle and engages with the pivotal portion of the head to position the connecting rod in the first position or the second position.

In an example, the pivotal portion of the head includes a toothed portion. The positioning device includes a slideable button, an elastic member, and a pawl. The slideable button is received in the receptacle, is slideable along the sliding axis perpendicular to the first axis, and includes a stepped groove having a varied depth along the first axis that varies along the sliding axis. The elastic element is mounted between a bottom wall of the receptacle and the slideable button. The pawl is received in the passage, abuts against the stepped groove of the slideable button, and engages with the toothed portion of the head. When the slideable button slides in the receptacle along the sliding axis, the pawl slides along the varied depth of the stepped groove to move along the first axis to thereby change an engagement relationship between the pawl and the toothed portion of the head.

In an example, the toothed portion includes a plurality of teeth. A valley is defined between two adjacent teeth. A third axis at an angle of 15° to the first axis passes through one of the valleys and a central axis of the pivotal member.

In an example, the abutting end of the connecting rod includes an abutting groove. The torque device includes a clutch member and a biasing member. The clutch member is biased by a biasing force provided by the biasing member to disengageably engage with the abutting groove. The biasing member is mounted between the clutch member and the adjusting device. The biasing force of the biasing member exerted on the clutch member is adjustable in response to a displacement of the adjusting device relative to the body to thereby set the initial torque value. The clutch member disengages from the abutting groove when a force larger than the initial torque valve is applied to the torque wrench.

In an example, the adjusting device includes a handle, a threaded member, a screw rod, and a pushing member. The handle is rotatably mounted to the second end of the body. The threaded member is mounted in the handle and includes a screw hole. The screw rod extends through and is in threading connection with the screw hole of the threaded member. The screw rod is movable relative to the threaded member along the first axis. The pushing member is mounted to an end of the screw rod opposite to the threaded member. The pushing member adjusts a pushing force exerted on the biasing member in response to a displacement of the screw rod relative to the threaded member along the first axis.

In an example, the adjusting device further includes an indicator mounted to the pushing member. The measuring unit senses a displacement of the indicator related to the displacement of the screw rod along the first axis to thereby measure the initial torque value that is set by the pushing member pressing against the biasing member.

In an example, the operating unit includes a first button, a second button, a third button. The first button is configured to set the operating unit to the first mode and to display the first corrected torque value on the display unit. The second button is configured to set the operating unit to the second mode and to display the second corrected torque value on the display unit. The first corrected torque value and the second corrected torque value are displayable on the display unit in one of two units. The third button is configured to switch the first corrected torque value or the second corrected torque value displayed on the display unit between the two units.

In an example, the operating unit is a printed circuit board.

Illustrative embodiments will become clearer in light of the following detailed description described in connection with the drawings.

### DESCRIPTION OF THE DRAWINGS

The illustrative embodiments may best be described by reference to the accompanying drawings where:

FIG. 1 is a perspective view of a torque wrench of an embodiment according to the present invention.

FIG. 2 is an exploded, perspective view of the torque wrench of FIG. 1.

FIG. 3 is a cross sectional view of the torque wrench of FIG. 1 with a connecting rod in a first position and with an operating unit in a first mode.

FIG. 4 is another cross sectional view of the torque wrench of FIG. 1 with a clutch member engaged with an abutting groove.

FIG. 5 is a view similar to FIG. 4 with the clutch member disengaged from the abutting groove due to a force larger than a initial torque value set by a biasing member.

FIG. 6 is a diagrammatic cross sectional view illustrating use of the torque wrench of FIG. 1 with the connecting rod in a second position and with the operating unit in the first mode.

FIG. 7 is a diagrammatic cross sectional view illustrating use of the torque wrench of FIG. 1 with the connecting rod in the second position and with the operating unit in a second mode.

### DETAILED DESCRIPTION

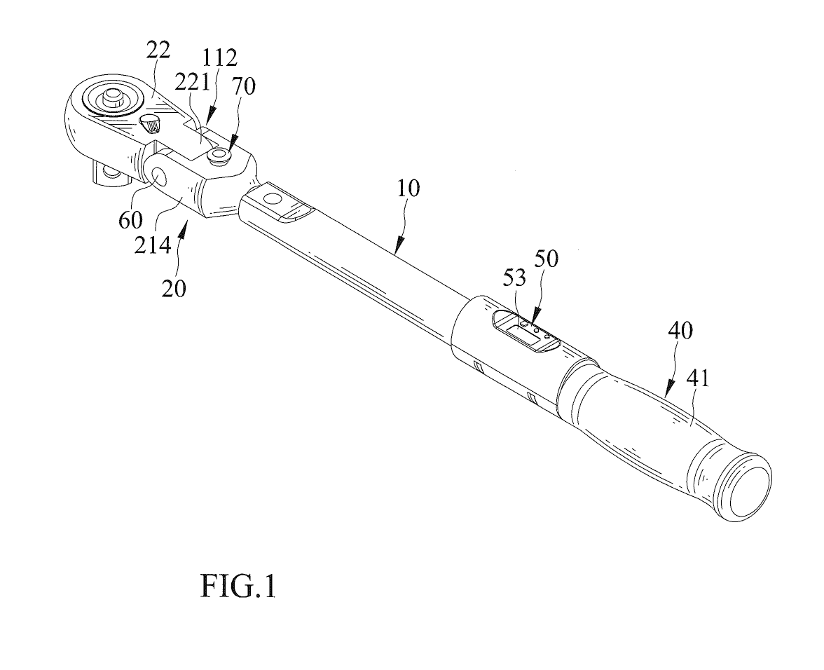

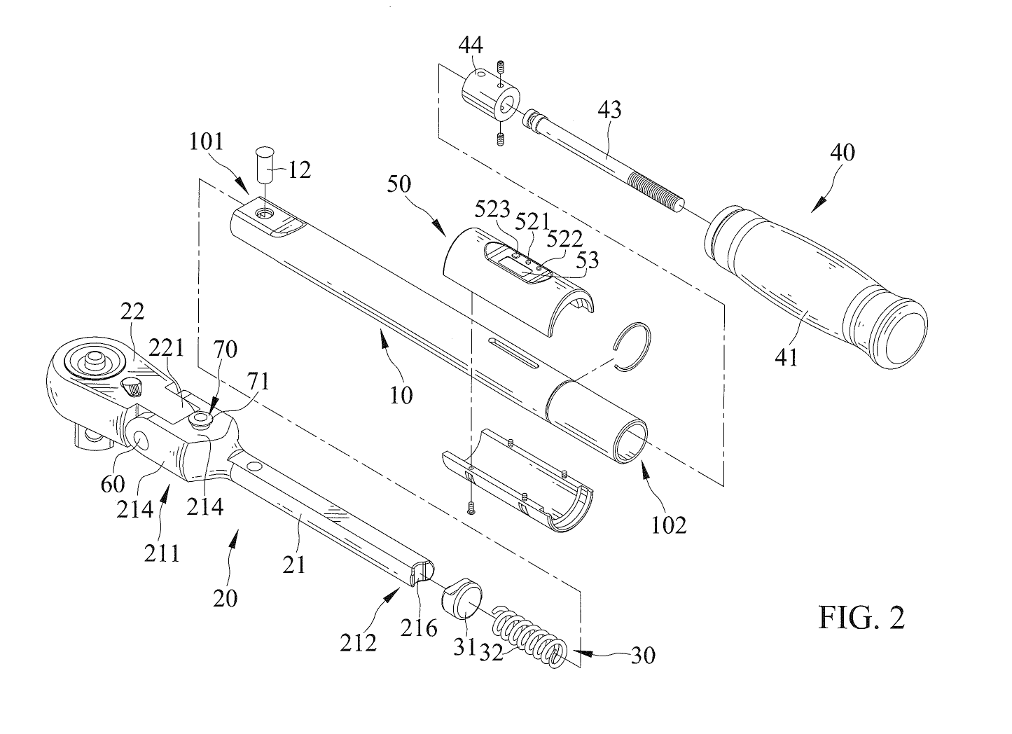

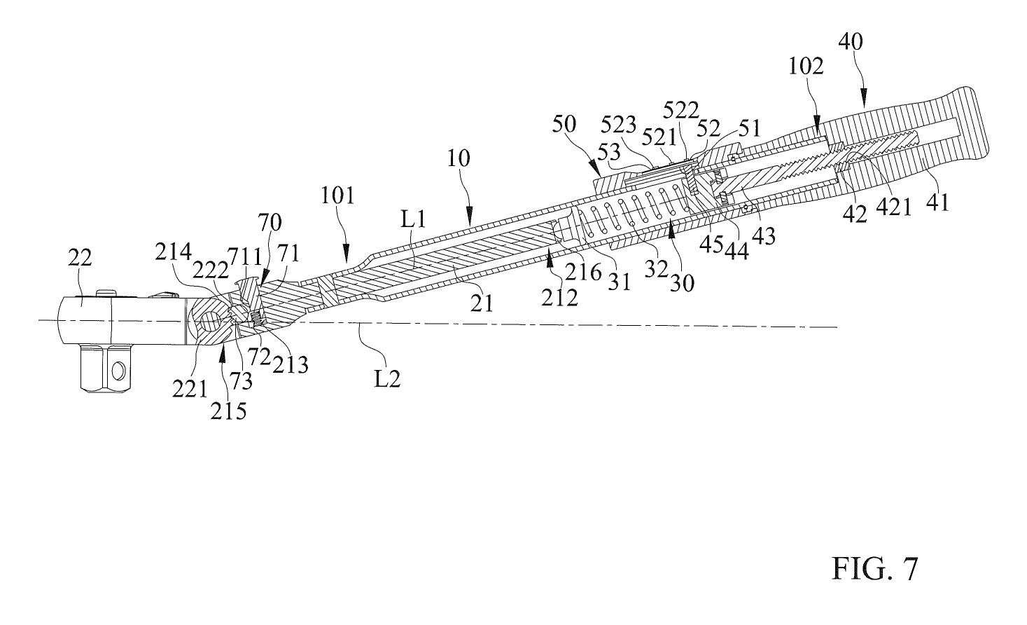

FIGS. 1-7 show a torque wrench of an embodiment according to the present invention. The torque wrench includes a body 10, a driving device 20, a torque device 30, an adjusting device 40, and an operating device 50.

Body 10 includes a first end 101 and a second end 102. In this embodiment, body 10 is a hollow cylindrical member. First end 101 of body 10 includes two flat faces respectively on two sides thereof.

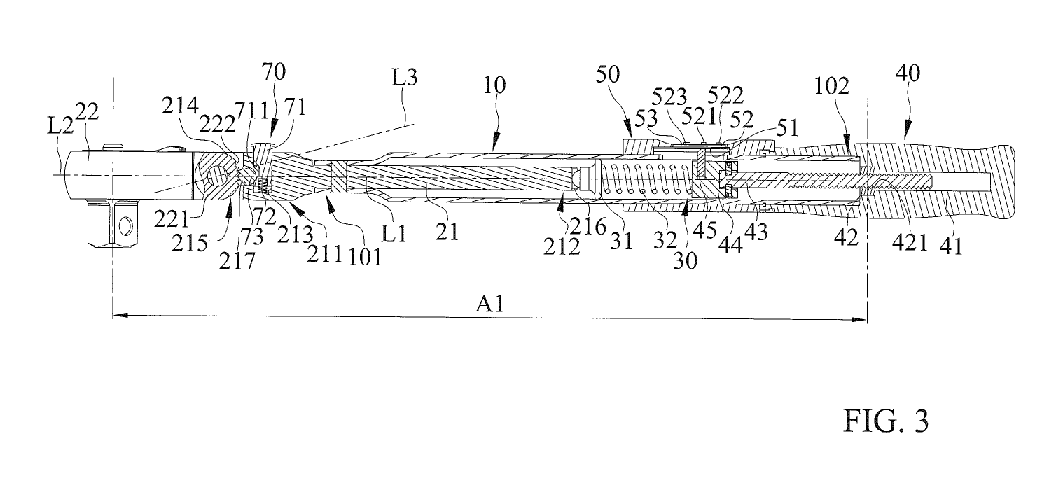

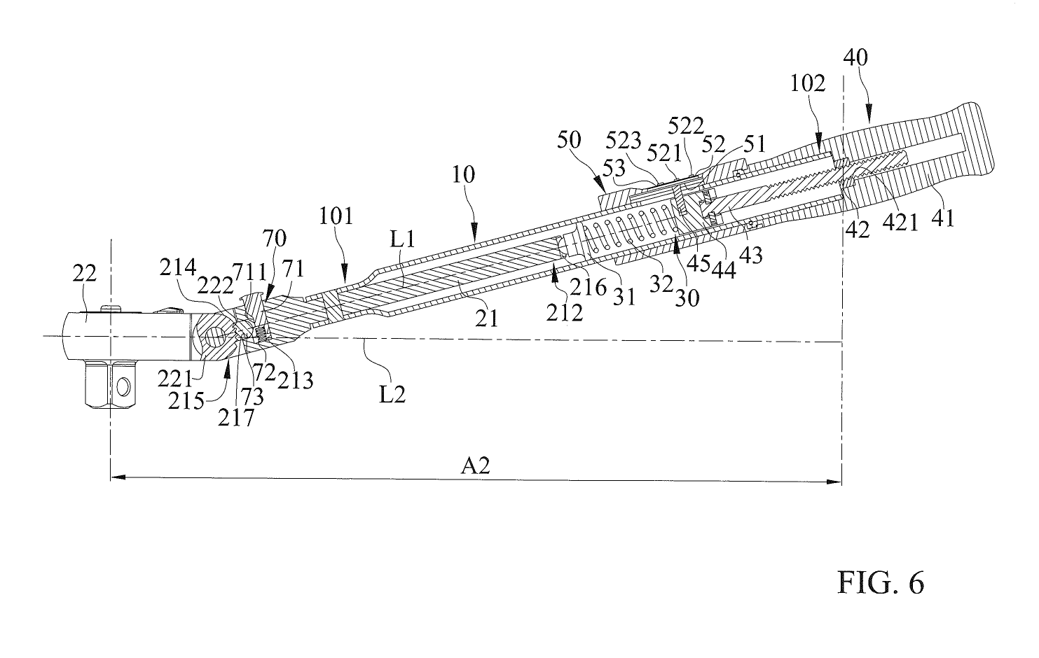

Driving device 20 includes a connecting rod 21 and a head 22. Connecting rod 21 is pivotably connected to first end 101 of body 10 by a pin 12. Connecting rod 21 includes a pivotal end 211 and an abutting end 212. Pivotal end 211 is pivotably connected to head 22. Connecting rod 21 is pivotable relative to head 22 between a first position and a second position. The torque wrench has a first lever arm A1 when connecting rod 21 is in the first position (see FIG. 3). The torque wrench has a second lever arm A2 when connecting rod 21 is in the second position (see FIG. 6). Thus, after adjusting a working angle of the torque wrench, head 22 can directly or indirectly couple with a workpiece, such as a socket or an extension.

In this embodiment, connecting rod 21 extends along a first axis L1. Pivotal end 211 is spaced from abutting end 212 along first axis L1. Head 22 is adapted to drive a fastener to rotate about a rotating axis. Head 22 extends along a second axis L2 perpendicular to the rotating axis. Pivotal end 211 of connecting rod 21 is spaced from the rotating axis along second axis L2. First axis L1 is coincident with second axis L2 (0° position) when connecting rod 21 is in the first position. When connecting rod 21 is in the second position, first axis L1 is at an angle of 15° to second axis L2. Thus, the torque wrench can be positioned in the 0° position or the 15° position to avoid ineffective operation due to hindrance by obstruction during rotation of the torque wrench.

A receptacle 213 is defined in pivotal end 211 of connecting rod 21 and extends in a sliding axis perpendicular to first axis L1. Pivotal end 211 of connecting rod 21 includes two arms 214 defining a pivotal groove 215 therebetween and extending parallel to first axis L1. Pivotal groove 215 intercommunicates with receptacle 213 via a passage 217. Abutting end 212 of connecting rod 21 includes an abutting groove 216.

Head 22 includes a pivotal portion 221 received in pivotal groove 215 between two arms 214. Pivotal portion 221 of head 22 includes a toothed portion 222. In this embodiment, toothed portion 222 includes a plurality of teeth. A valley is defined between two adjacent teeth. A third axis L3 at an angle of 15° to the first axis L1 passes through one of the valleys and a central axis of a pivotal member 60. First axis L1 passes through another valley of toothed portion 222 and the central axis of pivotal member 60. The working angle can be fixed in 0° or 15°.

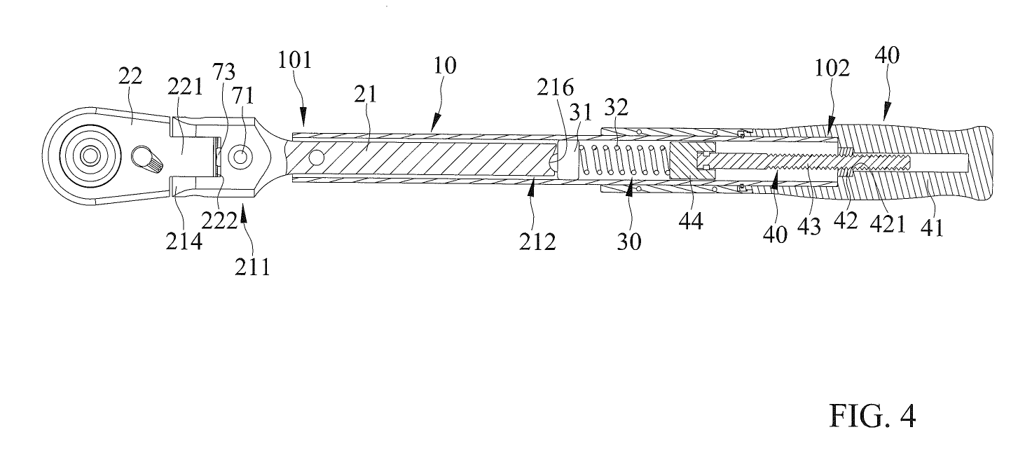

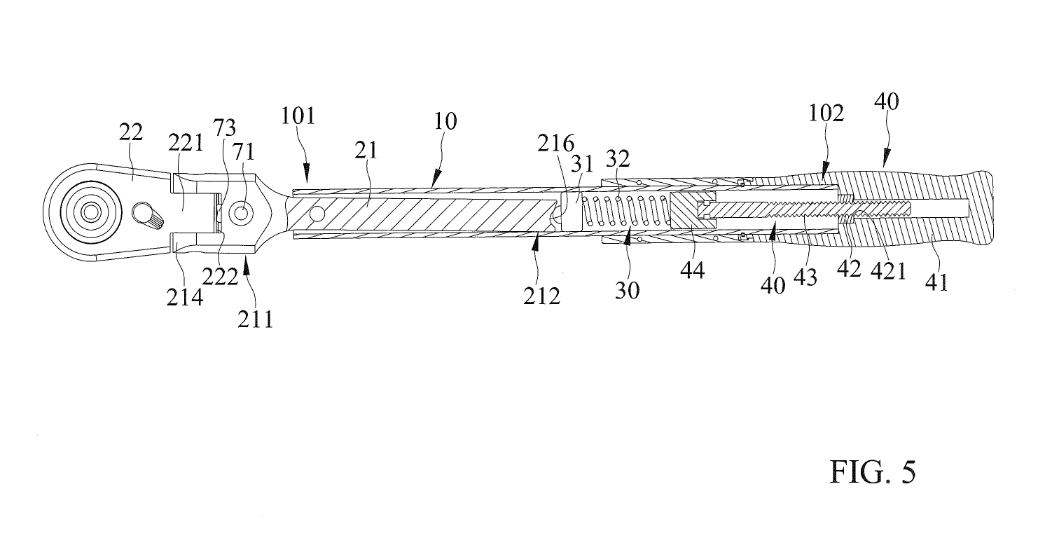

Torque device 30 is mounted to body 10 and elastically presses against abutting end 212 of connecting rod 21. Torque device 30 includes a clutch member 31 and a biasing member 32. Clutch member 31 is biased by a biasing force provided by biasing member 32 to disengageably engage with abutting groove 216. Biasing member 32 is mounted between clutch member 31 and adjusting device 40. The biasing force of biasing member 32 exerted on clutch member 31 is adjustable in response to a displacement of adjusting device 40 relative to body 10 to thereby set the initial torque value (see FIG. 4). Clutch member 31 disengages from abutting groove 216 when a force larger than the initial torque valve set by using biasing member 32 is applied to the torque wrench (see FIG. 5).

Adjusting device 40 is movably mounted to second end 102 of body 10 and is operatively connected to torque device 30 for setting the initial torque value. In this embodiment, adjusting device 40 sets the initial torque value by pressing torque device 30.

Adjusting device 40 includes a handle 41, a threaded member 42, a screw rod 43, and a pushing member 44. Handle 41 is rotatably mounted to second end 102 of body 10 and is not moveable relative to second end 102 of body 10 along first axis L1. Threaded member 42 is mounted in the handle 41 and includes a screw hole 421. Screw rod 43 extends through and is in threading connection with screw hole 421 of threaded member 42. Screw rod 43 is movable relative to threaded member 42 along first axis L1. Pushing member 44 is mounted to an end of screw rod 43 opposite to threaded member 42. Pushing member 44 adjusts a pushing force exerted on biasing member 32 in response to a displacement of screw rod 43 relative to threaded member 42 along first axis L1. Adjusting device 40 further includes an indicator 45 mounted to the pushing member 44.

Operating device 50 is mounted to body 10 and includes a measuring unit 51, an operating unit 52, and a display unit 53. Measuring unit 51, operating unit 52, and display unit 53 are electrically connected to each other. Measuring unit 51 is configured to measure the initial torque value set by using adjusting device 40 to press against torque device 30. Operating unit 52 has a first mode and a second mode. When operating unit 52 is in the first mode, operating unit 52 multiplies the initial torque value by a first correction coefficient corresponding to first lever arm A1 to obtain a first corrected torque value. When operating unit 52 is in the second mode, operating unit 52 multiplies the initial torque value by a second correction coefficient corresponding to second lever arm A2 to obtain a second corrected torque value. Measuring unit 51 senses a displacement of indicator 45 related to the displacement of screw rod 43 along first axis L1 to thereby measure the initial torque value that is set by pushing member 44 pressing against biasing member 32.

Display unit 53 displays the first corrected torque value or the second corrected torque value according to the first mode or the second mode of operating unit 52. In this embodiment, operating unit 52 is a printed circuit board, and display unit 53 is an LCD screen.

Operating unit 52 includes a first button 521, a second button 522, a third button 523. First button 521 is configured to set operating unit 52 to the first mode and to display the first corrected torque value on display unit 53. Second button 522 is configured to set operating unit 52 to the second mode and to display the second corrected torque value on display unit 53. The first corrected torque value and the second corrected torque value are displayable on display unit 53 in one of two units, such as newton-meters and pound-feet. Third button 523 is configured to switch the first corrected torque value or the second corrected torque value displayed on the display unit 53 between the two units.

The torque wrench further includes a pivotal member 60 and a positioning device 70. Pivotal member 60 extends through two arms 214 and pivotal portion 221 to permit connecting rod 21 to pivot relative to head 22 to thereby adjust the working angle. Positioning device 70 is mounted in receptacle 213 and engages with head 22.

Positioning device 70 includes a slideable button 71, an elastic member 72, and a pawl 73. Slideable button 71 is received in receptacle 213 and is slideable along the sliding axis perpendicular to first axis L1. Slideable button 71 includes a stepped groove 711 having a varied depth along first axis L1 that varies along the sliding axis. Namely, the depth of stepped groove 711 of slideable button 71 along first axis changes from an end to another end of slideable button 71 along the sliding axis. Elastic element 72 is mounted between a bottom wall of receptacle 213 and slideable button 71. Pawl 73 is received in passage 217, abuts against stepped groove 711 of slideable button 71, and engages with toothed portion 222 of head 22. When the slideable button 71 slides in receptacle 213 along the sliding axis, pawl 73 slides along the varied depth of stepped groove 711 to move along first axis L1 to thereby change an engagement relationship between pawl 73 and toothed portion 222 of head 22.

Namely, when a user presses the slideable button 71 to compress elastic element 72, paw 73 moving along the varied depth of stepped groove 711 of slideable button 73 slides along first axis L1 and disengages from toothed portion 222 of head 22, and connecting head 21 is switchable between the first position and the second position. When the user stops pressing slideable button 71, the returning force of elastic element 72 pushes slideable button 71. Pawl 73 slides along first axis L1 to reengage with toothed portion 222 of head 22, achieving the positioning function.

Specifically, after the user uses adjusting device 40 to press against torque device 30 to set the initial torque value, when connecting rod 21 is in the first position and the initial torque value is set, operating unit 52 is switched to the first mode to obtain the first corrected torque value. The user can see the first corrected torque value from display unit 53, which is the real torque value provided by the torque wrench in the first position. When the user switches connecting rod 21 from the first position to the second position, the initial torque value will be changed when first lever arm A1 changes to second lever arm A2. Operating unit 52 is switched to the second mode to obtain the second corrected torque value, and the user can see the second corrected torque value from display unit 53, which is the real torque value provided by the torque wrench in the second position. Thus, after the working angle is changed, the torque wrench can digitally show the corrected torque value without delicate electronic elements. Thus, the manufacturing costs can be reduced to provide the customers with a torque wrench with a high capability/price ratio.

When connecting rod 21 is in the first position, the user firstly uses adjusting device 40 to press against torque device 30 to set the initial torque value. Namely, operating unit 52 is selected to be in the first mode or the second mode according to the first or second position of connecting rod 21. Namely, the user selects a suitable one of the first mode and the second mode according to the first lever arm A1 or the second lever arm A2 in the first position or the second position. The first corrected torque value can be obtained when operating unit 52 is switched to the first mode and can be seen from display unit 53 by the user, which is the real torque value provided by the torque wrench. In this embodiment, connecting rod 21 is in the first position relative to head 22, first axis L1 is coincident with second axis L2. Thus, the first correction coefficient is 1. Namely, the first corrected torque value is equal to the initial torque value.

When the user intends to changes the working angle, the slideable button 71 is pressed to compress elastic element 72. Pawl 73 slides along the varied depth of stepped groove 711 of slideable button 71 and, thus, slides along first axis L1 to disengage from toothed portion 222 of head 22. Connecting rod 21 is pivotable relative to head 22 from the first position to the second position. When the user stops pressing slideable button 71, connecting rod 21 is positioned in the second position. Accordingly, connecting rod 21 can be positioned in the first position or the second position relative to head 22, avoiding unintentional pivotal movement of connecting rod 21 while providing easy operation of changing the working angle.

At this time, connecting rod 21 is positioned in the second position, and first lever arm A1 is changed to second lever arm A2, leading to a change in the torque value. In this embodiment, first axis L1 is at an angle of 15° to second axis L2, such that the second correction coefficient is about 0.97. Assume first lever arm A1 is 1, when the angle between first axis L1 and second axis L2 is 15°, second lever arm A2 is equal to first lever arm A1 multiplied by cos 15°. Thus, the second corrected torque value is about 97% of the first corrected torque value. When operating unit 52 is switched to the second mode, the second corrected torque value can be obtained and can be seen from display unit 53 by the user. As a result, the user has to rotate handle 41 to increase the pressing force against biasing member 32, such that the second corrected torque value displayed on display unit 53 is equal to the desired initial torque value. By such an arrangement, even though connecting rod 21 is positioned in the second position relative to head 22 and causes a change from first lever arm A1 to second lever arm A2, the user can precisely control the torque value of the torque wrench.

When connecting rod 21 is switched from the second position back to the first position relative to head 22 and operating unit 52 is switched to the first mode, since second lever arm A2 changes back to first lever arm A1, the first corrected torque value displayed on display unit 53 is about 103% of the initial torque value. The user has to rotate handle 41 to reduce the pressing force against biasing member 32 until the first corrected torque value displayed on display unit 53 is equal to the initial torque value.

Thus since the illustrative embodiments disclosed herein may be embodied in other specific forms without departing from the spirit or general characteristics thereof, some of which forms have been indicated, the embodiments described herein are to be considered in all respects illustrative and not restrictive. The scope is to be indicated by the appended claims, rather than by the foregoing description, and all changes which come within the meaning and range of equivalency of the claims are intended to be embraced therein.

1. A torque wrench comprising:
a body including a first end and a second end;
a driving device including a connecting rod and a head, with the connecting rod pivotably connected to the first end of the body, with the connecting rod including a pivotal end and an abutting end, with the pivotal end pivotably connected to the head, with the connecting rod pivotable relative to the head between a first position and a second position, wherein the torque wrench has a first lever arm when the connecting rod is in the first position, and wherein the torque wrench has a second lever arm when the connecting rod is in the second position;
a torque device mounted to the body and pressing against the abutting end of the connecting rod;
an adjusting device movably mounted to the second end of the body and operatively connected to the torque device for setting an initial torque value; and
an operating device mounted to the body, with the operating device including a measuring unit, an operating unit, and a display unit, with the measuring unit, the operating unit, and the display unit electrically connected to each other, wherein the measuring unit is configured to measure the initial torque value,
wherein the operating unit has a first mode and a second mode, wherein when the operating unit is in the first mode, the operating unit multiplies the initial torque value by a first correction coefficient corresponding to the first lever arm to obtain a first corrected torque value,
wherein when the operating unit is in the second mode, the operating unit multiplies the initial torque value by a second correction coefficient corresponding to the second lever arm to obtain a second corrected torque value, and
wherein the display unit displays the first corrected torque value or the second corrected torque value according to the first mode or the second mode of the operating unit.

2. The torque wrench as claimed in claim 1, wherein the body is a hollow cylindrical member, wherein the connecting rod extends along a first axis, wherein the pivotal end is spaced from the abutting end along the first axis, wherein the head is adapted to drive a fastener to rotate about a rotating axis, wherein the head extends along a second axis perpendicular to the rotating axis, wherein the pivotal end of the connecting rod is spaced from the rotating axis along the second axis, wherein the first axis is coincident with the second axis when the connecting rod is in the first position, wherein when the connecting rod is in the second position, the first axis is at an angle of 15° to the second axis, and wherein the torque device elastically presses against the abutting end of the connecting rod.

3. The torque wrench as claimed in claim 2, wherein a receptacle is defined in the pivotal end of the connecting rod and extends along a sliding axis perpendicular to the first axis, wherein the pivotal end of the connecting rod includes two arms defining a pivotal groove therebetween, wherein the pivotal groove intercommunicates with the receptacle via a passage, wherein the head includes a pivotal portion received in the pivotal groove between the two arms,
wherein the torque wrench further comprises:
a pivotal member extending through the two aims and the pivotal portion to permit the connecting rod to pivot relative to the head between the first position and the second position; and
a positioning device mounted in the receptacle and engaged with the pivotal portion of the head to position the connecting rod in the first position or the second position.

4. The torque wrench as claimed in claim 3, wherein the pivotal portion of the head includes a toothed portion, wherein the positioning device includes a slideable button, an elastic member, and a pawl, wherein the slideable button is received in the receptacle, is slideable along the sliding axis perpendicular to the first axis, and includes a stepped groove having a varied depth along the first axis that varies along the sliding axis, wherein the elastic element is mounted between a bottom wall of the receptacle and the slideable button, wherein the pawl is received in the passage, abuts against the stepped groove of the slideable button, and engages with the toothed portion of the head, wherein when the slideable button slides in the receptacle along the sliding axis, the pawl slides along the varied depth of the stepped groove to move along the first axis to thereby change an engagement relationship between the pawl and the toothed portion of the head.

5. The torque wrench as claimed in claim 4, wherein the toothed portion includes a plurality of teeth, wherein a valley is defined between two adjacent teeth, wherein a third axis at an angle of 15° to the first axis passes through one of the valleys and a central axis of the pivotal member.

6. The torque wrench as claimed in claim 1, wherein the abutting end of the connecting rod includes an abutting groove, wherein the torque device includes a clutch member and a biasing member, wherein the clutch member is biased by a biasing force provided by the biasing member to disengageably engage with the abutting groove, wherein the biasing member is mounted between the clutch member and the adjusting device, wherein the biasing force of the biasing member exerted on the clutch member is adjustable in response to a displacement of the adjusting device relative to the body to thereby set the initial torque value, and wherein the clutch member disengages from the abutting groove when a force larger than the initial torque valve is applied to the torque wrench.

7. The torque wrench as claimed in claim 6, wherein the adjusting device includes a handle, a threaded member, a screw rod, and a pushing member, wherein the handle is rotatably mounted to the second end of the body, wherein the threaded member is mounted in the handle and includes a screw hole, wherein the screw rod extends through and is in threading connection with the screw hole of the threaded member, wherein the screw rod is movable relative to the threaded member along the first axis, wherein the pushing member is mounted to an end of the screw rod opposite to the threaded member, wherein the pushing member adjusts a pushing force exerted on the biasing member in response to a displacement of the screw rod relative to the threaded member along the first axis.

8. The torque wrench as claimed in claim 7, wherein the adjusting device further includes an indicator mounted to the pushing member, wherein the measuring unit senses a displacement of the indicator related to the displacement of the screw rod along the first axis to thereby measure the initial torque value that is set by the pushing member pressing against the biasing member.

9. The torque wrench as claimed in claim 1, wherein the operating unit includes a first button, a second button, a third button, wherein the first button is configured to set the operating unit to the first mode and to display the first corrected torque value on the display unit, wherein the second button is configured to set the operating unit to the second mode and to display the second corrected torque value on the display unit, wherein the first corrected torque value and the second corrected torque value are displayable on the display unit in one of two units, and wherein the third button is configured to switch the first corrected torque value or the second corrected torque value displayed on the display unit between the two units.

10. The torque wrench as claimed in claim 1, wherein the operating unit is a printed circuit board.
